(19) United States
(12) Patent Application Publication
(10) Pub. No.: US 2026/0219152 A1
(43) Pub. Date: Jul. 30, 2026

(54) SYSTEM AND METHOD FOR MEASURING PARTICLE SIZE DISTRIBUTION OF SEDIMENT GRAINS

(71) Applicant: XI'AN UNIVERSITY OF TECHNOLOGY, Xi'an (CN)

(72) Inventors: Wen WANG, Xi'an (CN); Ziyue TANG, Xi'an (CN); Lei LI, Xi'an (CN); Jiao ZHANG, Xi'an (CN); Ke XIANG, Xi'an (CN); Zhanbin LI, Xi'an (CN); Peng LI, Xi'an (CN); Peng SHI, Xi'an (CN); Guoce XU, Xi'an (CN); Mengjing GUO, Xi'an (CN); Minghao DENG, Xi'an (CN); Hunan QIU, Xi'an (CN); Chenxin LAI, Xi'an (CN)

(73) Assignee: XI'AN UNIVERSITY OF TECHNOLOGY, Xi'an (CN)

(21) Appl. No.: 19/407,027

(22) Filed: Dec. 3, 2025

(30) Foreign Application Priority Data
Jan. 26, 2025 (CN) 2025101218238

(51) Int. Cl. G01N 15/0227; G01N 15/00; G06V 10/141; G06V 10/26; G06V 10/44; G06V 10/762

(52) U.S. Cl. CPC G01N 15/0227; G06V 10/141; G06V 10/26; G06V 10/443; G06V 10/763; G01N 2015/0053

(57) ABSTRACT

The present disclosure proposes a system and method for measuring particle size distribution of sediment grains. The method includes: acquiring a first sediment grain image and a second sediment grain image; processing the first sediment grain image to obtain a sediment grayscale image; obtaining a depth image based on the sediment grain images, and obtaining a depth grayscale image by processing the depth image; based on the depth grayscale image, generating a preliminary region mask; cropping the sediment grayscale image using the preliminary region mask; obtaining an image with first-stage clustering results by performing cluster analysis on the cropped sediment grayscale image; obtaining an image with second-stage clustering results by performing cluster analysis on the sediment grains with a particle size smaller than a preset threshold in the image with first-stage clustering results using a DBSCAN; obtaining the particle size distribution result based on the image with second-stage clustering results.

### CROSS-REFERENCE TO RELATED APPLICATIONS

The application claims priority to Chinese patent application No. 2025101218238, filed on Jan. 26, 2025, the entire contents of which are incorporated herein by reference.

### TECHNICAL FIELD

The present disclosure belongs to the technical field of water conservancy engineering, and in particular to a system and method for measuring particle size distribution of sediment grains.

### BACKGROUND

The particle size and gradation of sediment grains are critical parameters for studying sediment transport, scouring, and deposition, and are key to revealing the principles of sediment movement. Accurate data on particle size and gradation of sediment grains enables the summarization of precise sediment transport laws, thereby facilitating the formulation of reasonable and effective water-sediment regulation measures. This is of great engineering significance for river channel regulation, flood control and disaster mitigation. Consequently, the technical research aimed at acquiring particle sizes and gradation of sediment gains in water bodies is receiving increasing attention.

Currently, commonly used methods for measuring particle sizes of sediment grains include sieving, laser particle size measuring, sedimentation, and microscopy. However, these methods have relatively limited application scopes and suffer from drawbacks such as being time-consuming, labor-intensive, costly, and having weak discrimination capabilities for fine particles. For example, laser particle size measurement methods require sample preparation and dilution prior to measurement and analysis, rendering the entire process time-consuming. Furthermore, the laser particle size analyzers employed are expensive and require periodic maintenance and calibration during long-term operation. Based on the principle of light scattering, laser particle size analyzers primarily provide particle size distribution information, but cannot intuitively display the morphological characteristics of sediment grains, such as shape and irregularity. In contrast, digital image processing technology has irreplaceable advantages. As a particle size analysis technique, digital image processing technology exhibits excellent applicability, low cost, and the capability of segmenting sediment grains from images rapidly, accurately and in real time and calculating information, such as particle size and gradation, of sediment grains in the images. Nevertheless, existing systems for measuring particle sizes of sediment grains based on digital image processing technology suffer from low measurement accuracy in complex underwater environments, such as those with high sediment concentrations or abundant fine particles.

### SUMMARY

To overcome the shortcomings of the existing techniques, the present disclosure proposes a system and method for measuring particle size distribution of sediment grains, which solves the problem of low measurement accuracy suffered by the existing systems for measuring particle sizes of sediment grains in complex underwater environments with high sediment concentrations and abundant fine particles.

The objective of the present disclosure is achieved by the following technical solutions.

A system for measuring particle size distribution of sediment grains includes:
an image acquisition module including a first camera and a second camera, wherein the first camera is configured to acquire an image of sediment grains in a water body to obtain a first sediment grain image, and transmit the first sediment grain image to an image preprocessing module, and the second camera is configured to acquire an image of the sediment grains in the water body to obtain a second sediment grain image, and transmit the second sediment grain image to the image preprocessing module;
the image preprocessing module, configured to obtain a sediment grayscale image by performing grayscale processing and median filter processing on the first sediment grain image, and transmit the sediment grayscale image to a grain identification module, and further configured to obtain a depth image based on the first sediment grain image and the second sediment grain image, then obtain a depth grayscale image by performing grayscale processing and median filter processing on the depth image, and transmit the depth grayscale image to the grain identification module;
the grain identification module, configured to output a preliminary region mask for sediment grains based on the depth grayscale image and a preset depth value range, crop the sediment grayscale image using the preliminary region mask, identify the sediment grains and obtain an image with first-stage clustering results by performing cluster analysis on the cropped sediment grayscale image using a K-means clustering algorithm, obtain an image with second-stage clustering results by performing cluster analysis on the sediment grains with a particle size smaller than a preset threshold in the image with first-stage clustering results using a DBSCAN clustering algorithm, and transmit the image with second-stage clustering results to an edge detection module;
the edge detection module, configured to obtain a grain edge contour map by performing edge detection on the sediment grains in the image with second-stage clustering results, and transmit the grain edge contour map to an image binarization module;
the image binarization module, configured to obtain a binarized image by performing binarization processing on the grain edge contour map, and transmit the binarized image to an equivalent transformation module; and
the equivalent transformation module, configured to obtain the particle sizes of the sediment grains by performing an equivalent circular diameter transformation on the binarized image, and obtain a particle size distribution result by statistically analyzing the particle size distribution of the sediment grains.

Preferably, during the cluster analysis on the sediment grayscale image using the K-means clustering algorithm, the grain identification module employs a Davies-Bouldin index to evaluate the quality of the first-stage clustering results, employs a Q-learning reinforcement learning model to update the K value in the K-means clustering algorithm based on the obtained evaluation result, and then employs the K-means clustering algorithm with the updated K value to re-perform cluster analysis on the sediment grayscale image, until the first-stage clustering results meet a preset clustering performance stability condition.

Preferably, the image acquisition module includes a light source that is a blue light source; and
the light source is configured to provide illumination for the first camera to acquire an image of the sediment grains in the water body.

Furthermore, the system for measuring particle size distribution of sediment grains further includes a power consumption management module; and
the power consumption management module includes:
a light sensor configured to acquire illuminance intensity in the water body and transmit the illuminance intensity to a light source control module; and
the light source control module configured to control the irradiation intensity of the light source based on the illuminance intensity in the water body.

Furthermore, the system for measuring particle size distribution of sediment grains further includes a concentration calculation module, and the power consumption management module further includes a camera control module;
the concentration calculation module is configured to calculate a concentration of the sediment grains based on the particle size distribution result; and
the camera control module is configured to control the operating frequency of the first camera based on the concentration of the sediment grains.

Preferably, the edge detection module employs a Prewitt operator to perform edge detection on the sediment grains in the image with the second-stage clustering results.

A method for measuring particle size distribution of sediment grains includes:
acquiring an image of sediment grains in a water body to obtain a first sediment grain image;
acquiring an image of the sediment grains in the water body to obtain a second sediment grain image;
obtaining a sediment grayscale image by performing grayscale processing and median filter processing on the first sediment grain image;
obtaining a depth image based on the first sediment grain image and the second sediment grain image, and then obtaining a depth grayscale image by performing grayscale processing and median filter processing on the depth image;
outputting a preliminary region mask for sediment grains based on the depth grayscale image and a preset depth value range, cropping the sediment grayscale image using the preliminary region mask, identifying the sediment grains and obtaining an image with first-stage clustering results by performing cluster analysis on the cropped sediment grayscale image using a K-means clustering algorithm, and obtaining an image with second-stage clustering results by performing cluster analysis on the sediment grains with a particle size smaller than a preset threshold in the image with first-stage clustering results using a DBSCAN clustering algorithm;
obtaining a grain edge contour map by performing edge detection on the sediment grains in the image with second-stage clustering results;
obtaining a binarized image by performing binarization processing on the grain edge contour map; and
obtaining the particle sizes of the sediment grains by performing an equivalent circular diameter transformation on the binarized image, and obtaining a particle size distribution result by statistically analyzing the particle size distribution of the sediment grains.

Preferably, during the cluster analysis on the sediment grayscale image using the K-means clustering algorithm, a Davies-Bouldin index (DBI) is used to evaluate the quality of the first-stage clustering results, the K value in the K-means clustering algorithm is updated using a Q-learning reinforcement learning model based on the obtained evaluation result, and then the K-means clustering algorithm with the updated K value is used to re-perform cluster analysis on the sediment grayscale image, until the first-stage clustering results meet the preset clustering performance stability condition.

Compared with the prior art, the present disclosure has the following beneficial effects.

The system of the present disclosure employs two cameras to acquire images from different perspectives, converts the images from different perspectives into depth values to obtain three-dimensional information, and based on analysis on and processing of the three-dimensional information, achieves relatively accurate and intuitive identification of the morphology of suspended sediment grains in a water body, such that the pixel areas corresponding to the sediment grains in the images can be rapidly and efficiently obtained, and particle sizes of the sediment grains can be obtained after equivalent circular diameter transformation to calculate the particle gradation in the region. Compared with existing laser particle size measurement methods, the present disclosure features a shorter detection time, enables real-time measurement and reduces processing time to within 2 seconds, making it satisfy real-time monitoring requirements. Furthermore, the present disclosure has relatively high accuracy, achieving an excellent balance between real-time performance and high precision. Furthermore, the solution based on image identification in the present disclosure offers the advantages of low hardware costs, presenting significant economic advantages. Moreover, it can intuitively display the morphological characteristics of sediment grains, and provide information on particle size, shape and spatial distribution simultaneously, making it more suitable for comprehensive analysis. Compared with existing systems for measuring particle sizes of sediment grains based on digital image processing technology, the system for measuring particle size distribution of sediment grains of the present disclosure integrates the K-means clustering algorithm and the Density-Based Spatial Clustering of Applications with Noise (DBSCAN) algorithm. The K-means clustering algorithm can efficiently process large datasets of sediment grains, while the DBSCAN clustering algorithm exhibits greater adaptability in detecting high-density regions and fine-grained particles, effectively identifying clusters of arbitrary shapes. Therefore, the present disclosure first uses the K-means clustering algorithm for initial clustering, followed by the DBSCAN clustering algorithm for further classification of fine sediment grains. The synergistic interaction of these two algorithms allows for rapid and highly efficient identification of sediment grains in complex underwater environments with high sediment concentrations and abundant fine particles. This results in superior environmental adaptability and high identification accuracy.

Furthermore, the system of the present disclosure employs a reinforcement learning algorithm to adaptively and dynamically adjust the K value in the K-means clustering algorithm, thereby further improving the measurement accuracy of the system in environments with varying water quality and particle sizes of sediment grains.

Furthermore, in the system of the present disclosure, a blue light source is employed. Blue light has a shorter wavelength, and water has a lower absorption rate for blue light, allowing blue light to travel a longer time in water. This ensures that the images of sediment grains captured in underwater environments at greater distances from the cameras exhibit higher clarity. Therefore, using a blue light source enables the system of the present disclosure to be suitable for capturing clear images of sediment grains in complex underwater environments.

Furthermore, during underwater identification, the system of the present disclosure automatically adjusts the irradiation intensity of the light source based on the illuminance intensity in the underwater environment, enabling effective management of power consumption. As a result, the endurance is improved, and the system is enabled to work underwater for extended periods, providing continuous and reliable data acquisition and analysis even when frequent maintenance is inconvenient.

Furthermore, the system of the present disclosure automatically adjusts the operating frequency of the cameras by analyzing the concentration of the sediment grains in the water body in real time, effectively reducing power consumption and increasing the battery endurance of the camera. This enables the measurement system to work underwater for extended periods, providing continuous and reliable data acquisition and analysis even when frequent maintenance is inconvenient.

In the method for measuring particle size distribution of sediment grains of the present disclosure, images of sediment grains in a water body are acquired from different perspectives, the images from different perspectives are converted into a depth image to obtain three-dimensional information, and based on analysis on and processing of the three-dimensional information, the morphology of suspended sediment grains in the water body can be accurately and intuitively identified. As a result, the pixel areas corresponding to the sediment grains in the image can be rapidly and efficiently obtained, and particle sizes of the sediment grains can be obtained after equivalent circular diameter transformation to calculate the particle gradation. The present disclosure integrates the K-means clustering algorithm and the DBSCAN clustering algorithm, enabling identification of sediment grains in complex underwater environments with high sediment concentrations and abundant fine particles. This results in superior environmental adaptability and high identification accuracy.

Furthermore, the present disclosure employs a reinforcement learning algorithm to adaptively and dynamically adjust the K value in the K-means clustering algorithm, thereby further improving the measurement accuracy in environments with varying water quality and particle sizes of sediment grains.

### BRIEF DESCRIPTION OF DRAWINGS

To illustrate the technical solutions in the embodiments of the present disclosure or in the prior art more clearly, the drawings to be used in the description of the embodiments or the prior art will be briefly introduced below. Obviously, the drawings to be described below are some embodiments of the present disclosure, and for those skilled in the art, other drawings can be obtained based on these drawings without creative effort.

FIG. 1 is a flowchart of a method for measuring particle size distribution of sediment grains in the present disclosure;

FIG. 2 is a schematic diagram illustrating the principle of measuring sediment grain depth values using a first camera and a second camera in the present disclosure;

FIG. 3 is a sediment grain image acquired in an embodiment of the present disclosure;

FIG. 4 is a grayscale image obtained by performing grayscale transformation processing and median filter processing on the sediment grain image in an embodiment of the present disclosure;

FIG. 5 is an image having been processed by the K-means clustering algorithm and the DBSCAN clustering algorithm in the embodiments of the present disclosure;

FIG. 6 is an image after edge detection using a Prewitt operator and binarization processing in an embodiment of the present disclosure;

FIG. 7 is a particle size gradation curve of sediment grains obtained with a sediment feeding amount of 480 g in an embodiment of the present disclosure;

FIG. 8 is a particle size gradation curve of sediment grains obtained with a sediment feeding amount of 4000 g in an embodiment of the present disclosure; and

FIG. 9 is a particle size gradation curve of sediment grains obtained with a sediment feeding amount of 8000 g in an embodiment of the present disclosure.

### DETAILED DESCRIPTION OF THE EMBODIMENTS

Implementations of the present disclosure will be described in the following with reference to specific embodiments. Those skilled in the art can readily appreciate other advantages and efficacies of the present disclosure from the content disclosed in this specification. The present disclosure may also be implemented or applied through different specific implementations. Various details in this specification may also be modified or altered based on different perspectives and applications without departing from the spirit of the present disclosure.

It is to be noted that any process apparatus or device not specifically specified in the following embodiments shall employ conventional apparatus or device in the field.

It is to be noted that the terms “include,” “have,” and any variations thereof are intended to cover non-exclusive inclusion. For example, a process, method, system, product, or apparatus that includes a series of steps or units is not necessarily limited to those expressly listed steps or units, but may include other steps or units not explicitly listed or inherent to such process, method, product, or apparatus. Furthermore, unless otherwise specified, the numbering of method steps is merely a convenient tool for identifying each method step, and is not intended to limit the sequence of the method steps or define the scope in which the present disclosure may be practiced. Changes or adjustments in the relative relationship of steps, provided that they do not substantially alter the technical content, shall also be considered to fall within of the scope of the present disclosure. Furthermore, it is to be noted that the terms “first,” “second,” etc., in the present disclosure are used to distinguish similar objects and are not necessarily used to describe a specific order or sequence.

A system for measuring particle size distribution of sediment grains in the present disclosure includes:
an image acquisition module including a first camera and a second camera, wherein the first camera is configured to acquire an image of sediment grains in a water body to obtain a first sediment grain image, and transmit the first sediment grain image to an image preprocessing module, and the second camera is configured to acquire an image of the sediment grains in the water body to obtain a second sediment grain image, and transmit the second sediment grain image to the image preprocessing module;
the image preprocessing module, configured to obtain a sediment grayscale image by performing grayscale processing and median filter processing on the first sediment grain image, and transmit the sediment grayscale image to a grain identification module, and further configured to obtain a depth image based on the first sediment grain image and the second sediment grain image, then obtain a depth grayscale image by performing grayscale processing and median filter processing on the depth image, and transmit the depth grayscale image to the grain identification module;
the grain identification module, configured to output a preliminary region mask for sediment grains based on the depth grayscale image and a preset depth value range, crop the sediment grayscale image using the preliminary region mask, identify the sediment grains and obtain an image with first-stage clustering results by performing cluster analysis on the cropped sediment grayscale image using a K-means clustering algorithm, obtain an image with second-stage clustering results by performing cluster analysis on the sediment grains with a particle size smaller than a preset threshold in the image with first-stage clustering results using a DBSCAN clustering algorithm, and transmit the image with second-stage clustering results to an edge detection module;
the edge detection module, configured to obtain a grain edge contour map by performing edge detection on the sediment grains in the image with second-stage clustering results, and transmit the grain edge contour map to an image binarization module;
the image binarization module, configured to obtain a binarized image by performing binarization processing on the grain edge contour map, and transmit the binarized image to an equivalent transformation module; and
the equivalent transformation module, configured to obtain the particle sizes of the sediment grains by performing an equivalent circular diameter transformation on the binarized image, and obtain a particle size distribution result by statistically analyzing the particle size distribution of the sediment grains.

In a preferable embodiment of the present disclosure, the first camera and the second camera are located on the same horizontal plane, and the angle between the optical axis of the first camera and the optical axis of the second camera is in the range from 50 to 70 degrees.

The present disclosure constructs a dual-camera image acquisition module by arranging the first camera and the second camera, thereby acquiring image data of sediment grains from multiple perspectives. Preferably, the first camera and the second camera are fixed on the same horizontal plane at an angle of 60 degrees. That means the angle between the optical axis of the first camera and the optical axis of the second camera is 60 degrees. A calibration plate is used to calibrate the cameras in the first camera and the second camera, to correct camera distortion and to determine the geometric relationship between the two cameras in the first camera and the second camera. The two cameras simultaneously capture images of sediment grains. Disparity values are calculated via a block matching algorithm in the image preprocessing module to generate the depth image, with each pixel value in the depth image representing the depth value of a corresponding point.

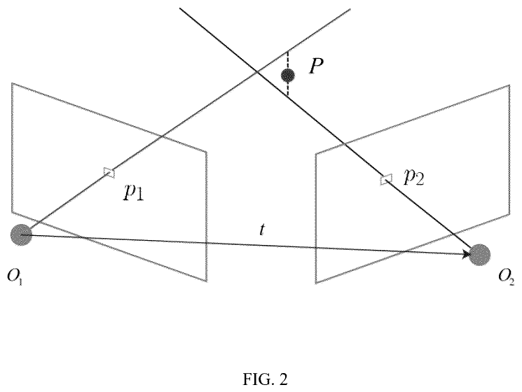

In the image preprocessing module, the disparity value for each pixel in the first sediment grain image and the second sediment grain image is determined by using the block matching algorithm, and the first sediment grain image and the second sediment grain image are converted into a depth image based on the disparity values and the triangulation principle (FIG. 2).

In FIGS. 2, O₁ and O₂ are the optical centers of the first camera and the second camera, respectively; p₁ and p₂ are the feature points in the first sediment grain image and the second sediment grain image, respectively; P is the position of the map point in the three-dimensional scene corresponding to the two feature points; and t is the translation vector.

Here, the depth value of each pixel can be calculated using the following formula:

$$Z = \frac{f \cdot \vert t \vert}{d}$$

where Z is the depth value (perpendicular distance) from the sediment grain to the baseline between the camera in the first camera and the camera in the second camera, f is the focal length of the camera in the first camera or the camera in the second camera, |t| is the baseline distance between the camera in the first camera and the camera in the second camera, and d is the disparity value.

The focal length of the camera in the first camera is equal to that of the camera in the second camera.

In another preferable embodiment of the present disclosure, the image acquisition module further includes a light source for providing illumination for the first camera and the second camera to acquire images of sediment grains in a water body. The light source is a blue light source with a wavelength in the range from 400 to 500 nm. Due to the influence of light scattering by sediment grains and water in the water body, the water exhibits a turbid appearance. Blue light has a shorter wavelength, and water has a lower absorption rate for blue light, allowing blue light to travel a longer time in water. This ensures that the images of sediment grains captured in underwater environments at greater distances from the cameras exhibit higher clarity. Therefore, using a blue light source enables the system of the present disclosure to be suitable for capturing clear images of sediment grains in complex underwater environments.

Furthermore, to enhance the endurance of the image acquisition module and ensure that the system can operate underwater for extended periods, a power consumption management module is designed and implemented in a preferable embodiment of the present disclosure.

The power consumption management module includes a light sensor and a light source control module;

the light sensor is configured to acquire illuminance intensity in the underwater environment and transmit it to the light source control module; and

the light source control module is configured to control the irradiation intensity of the light source based on the illuminance intensity in the underwater environment.

When the illuminance intensity in the underwater environment is high, the light source control module automatically reduces the irradiation intensity of the light source to decrease power consumption; whereas when the illuminance intensity in the underwater environment is low, the light source control module increases the irradiation intensity of the light source to ensure the quality of the captured sediment grain images.

The power consumption management module of the present disclosure may optionally further include a camera control module. The system for measuring particle size distribution of sediment grains further includes a concentration calculation module that calculates a concentration of the sediment grains based on the particle size distribution result. The camera control module controls the operating frequency of the cameras based on the concentration of the sediment grains in the water body. When the concentration of the sediment grains is low, for example, below a preset concentration, the camera control module controls to reduce the operating frequency of each camera in the image acquisition module, thereby lowering power consumption.

The image preprocessing module of the present disclosure includes a grayscale transformation module and an image filtering module. The grayscale transformation module is configured to convert the first sediment grain image and the depth image into a sediment grayscale image and a depth grayscale image, respectively. Each pixel is represented by only one grayscale value. Each pixel requires one grayscale value to represent its brightness or grayscale level, thereby reducing data dimensionality, simplifying the analysis process, and effectively accelerating processing speed. The image filtering module is configured to perform median filter processing on the sediment grayscale image and the depth grayscale image. Since the image acquisition module itself can introduce noise, which may cause errors in the analysis for studying sediment particle size distribution, it is necessary to perform median filtering on the sediment grain images. In the present disclosure, a median filter with a window size of 5×5 is preferably employed. The median value of all the pixel values within this window is found, and the pixel value at the center of the window is replaced with this median value. Random isolated noise points are removed, and the complete contours of the sediment grains are preserved, thereby enabling more accurate extraction of the required information.

In a preferable embodiment of the present disclosure, since in the depth grayscale image converted from the depth image, the depth values of sediment grains are relatively consistent while those of the background vary considerably, prior to performing cluster analysis, the grain identification module first outputs a preliminary region mask for sediment grains by delineating potential sediment grain regions based on a preset depth value range and the depth grayscale image. The preliminary region mask contains the approximate contour locations of sediment grains. Subsequently, combined with the sediment grayscale image, the preliminary region mask is used to crop the sediment grayscale image, retaining the regions potentially containing sediment grains. Then, cluster analysis is performed on the sediment grayscale image using a K-means clustering algorithm. The function of the depth image is to generate the preliminary region mask for sediment grains and then to distinguish sediment grains from the background.

The sediment grayscale image subject to cluster analysis in the following sections of the present disclosure may be the sediment grayscale image output by the image preprocessing module, or may be the sediment grayscale image cropped by the grain identification module using the preliminary region mask as described above.

To enhance the environmental adaptability and accuracy of the system, the grain identification module of the present disclosure adopts an approach that uses the K-means clustering algorithm and the DBSCAN clustering algorithm in combination to perform cluster analysis on the sediment grayscale image. The DBSCAN clustering algorithm exhibits stronger adaptability in detecting high-density regions and fine-grained particles, can effectively identify clusters of arbitrary shapes, and automatically determines the number of clusters, making it particularly suitable for identifying irregularly shaped sediment grains in complex underwater environments. Therefore, subsequent to performing cluster analysis using the K-means clustering algorithm, the present disclosure further employs the DBSCAN clustering algorithm for clustering fine-grained sediment particles. Specifically, the K-means clustering algorithm is first used to classify the pixel values of the sediment grayscale image to identify sediment grains, thereby obtaining an image with first-stage clustering results. Then, the DBSCAN clustering algorithm is used to perform cluster analysis again on the sediment grains with a particle size less than a preset threshold, thereby enabling precise identification of the fine sediment grains.

In the present disclosure, prior to performing cluster analysis using the K-means clustering algorithm, an “elbow” method is utilized to determine an initial optimal number of clusters K. This method determines the initial optimal number of clusters K by evaluating a core metric, i.e., the sum of squared errors (SSE). The SSE may intuitively reflect the clustering error. The smaller the value is, the better the clustering performance is, and the higher the degree of aggregation within each cluster is. When the simulated number of clusters (i.e. the number of cluster centroids) is less than the initial optimal number of clusters K, the larger the simulated number of clusters is, the higher the degree of aggregation within each cluster is, and then the greater the decrease in the SSE is. Whereas, when the simulated number of clusters is greater than the initial optimal number of clusters K, the resulting degree of aggregation within each cluster tends to stabilize as the simulated number of clusters increases. Consequently, the rate of decrease in the SSE becomes more gradual and eventually plateaus as the simulated number of clusters continues to grow, and the cluster centroids remain unchanged. Then, the position corresponding to the “elbow” is the initial optimal number of clusters K.

Here, the specific formula for the SSE is as follows:

$$H = {\sum }_{i = 1}^{k} {\sum }_{b ∈ {C}_{i}} {\vert b - {m}_{i} \vert}^{2}$$

where H is the SSE, Cᵢ represents the i-th cluster, b is the sample point of Cᵢ, and mᵢ is the centroid of Cᵢ.

During the execution of the K-means clustering algorithm, the initial optimal number of clusters K obtained by the above-mentioned “elbow” method is used as a fixed parameter during initialization. The present disclosure employs the K-means++ initialization method to select K initial cluster centroids based on the determined initial optimal number of clusters K. First, a first cluster centroid is selected, i.e., a pixel is randomly selected from the sediment grayscale image as the first cluster centroid. Subsequently, for each pixel in the sediment grayscale image, the shortest distance between it and the nearest selected cluster centroid is found and calculated. The square of this shortest distance is used as the weight of that pixel when the next cluster centroid is selected. When the next cluster centroid is selected, each pixel not yet selected as a cluster centroid has a probability of being selected that is proportional to its corresponding shortest distance. The greater the distance is, the higher the probability of being selected is. This process is repeated iteratively until K initial cluster centroids have been selected. The calculation of the shortest distance between each pixel and the selected cluster centroids is measured using the Euclidean distance.

The formula for calculating the Euclidean distance is as follows:

For the Euclidean distance between two points A(x₁,y₁) and B(x₂,y₂):

$$D ( A , B ) = \sqrt{{( {x}_{2} - {x}_{1} )}^{2} + {( {y}_{2} - {y}_{1} )}^{2}}$$

Subsequently, each pixel of the sediment grayscale image is traversed. The Euclidean distance between each pixel and each cluster centroid is calculated, and each pixel is assigned to the cluster represented by the cluster centroid to which it has the shortest distance. Once all pixels have been assigned to K clusters, the cluster centroid of each cluster is then updated. For each cluster, the average of all its pixel grayscale values is calculated and the pixel corresponding to this average value is set as the new cluster centroid. Then, the process is iterated until the cluster centroids no longer change significantly, such that the variation in pixel grayscale values among the pixels within the same cluster is minimized, while the pixel variation between different clusters is maximized. Consequently, effective segmentation and classification of the image is achieved, yielding the first-stage clustering results.

To maintain the high accuracy of the K-means clustering algorithm in environments with varying water quality and particle sizes of sediment grains, the present disclosure employs a reinforcement learning algorithm to dynamically and adaptively adjust the K value based on the distribution density and quantity of sediment grains during the execution of the K-means clustering algorithm. Through the reinforcement learning algorithm, the system can learn an optimal K value selected during the reinforcement learning process and its corresponding clustering parameters from the previous first-stage clustering results and the currently processed sediment grayscale image data, such that the K-means clustering algorithm can maintain high efficiency and accuracy in environments with varying water quality and particle sizes of sediment grains.

Specifically, during the execution of the K-means clustering algorithm, a Davies-Bouldin index is used to evaluate the quality of the obtained current first-stage clustering results. Based on the obtained evaluation result, the reinforcement learning algorithm is applied to progressively and adaptively adjust the K value. The adjusted K value is then used to re-perform cluster analysis, until the first-stage clustering results meet the quality requirements.

The present disclosure preferably employs a Q-learning reinforcement learning model to adaptively adjust the K value. The specific process is as follows. First, an environment is set up, which includes an input sediment grayscale image and parameter ranges (for particle size and shape); and the model parameters of the Q-learning reinforcement learning model are initialized. The system extracts features from the input image (i.e., the sediment grayscale image of the present disclosure) to obtain image features. The initial K-means clustering is performed using the initial optimal number of clusters determined by the “elbow” method to obtain preliminary first-stage clustering results. The value of a clustering performance metric (i.e., the Davies-Bouldin index) is then calculated. The current image features and the value of the clustering performance metric are combined to form a current state. Based on the current state, the Q-learning reinforcement learning model selects an action A (such as increasing, decreasing, or maintaining the K value) via a Q-table, and the K value is updated accordingly. After executing this action, the K-means clustering algorithm is run again to generate new first-stage clustering results. A new value of the clustering performance metric is calculated to form a new state. Based on the new state, a reward value is calculated and a Q-learning update rule is applied to optimize the Q-table, thereby optimizing future action selection. The entire process is iterated until the Davies-Bouldin index meets a preset clustering performance stability condition. The optimized K value, the first-stage clustering results, and the image with the first-stage clustering results are finally output.

The formula for optimization of the Q-table is as follows:

$$( {S}_{t} , {A}_{t} ) ← Q ( {S}_{t} , {A}_{t} ) + α [ R + γ {max}_{{A}^{′}} Q ( {S}_{t + 1} , {A}^{′} ) - Q ( {S}_{t} , {A}_{t} ) ]$$

where Sₜ represents the current state; Aₜ is the action selected under a given state Sₜ; R is the reward value obtained after performing the action Aₜ; Sₜ₊₁ is the new state reached after performing action Aₜ; A′ refers to all possible actions that can be taken in the new state Sₜ₊₁;

$${max}_{{A}^{′}} Q ( {S}_{t + 1} , {A}^{′} )$$

represents the Q-value corresponding to the optimal action A′ selected in the new state Sₜ₊₁, i.e., the maximum long-term reward that can be obtained in the future state; α represents the learning rate used to control the update speed, and y is the discount factor.

The edge detection module of the present disclosure is used for the image after the identification of sediment grains, that is, it processes the image with second-stage clustering results. In a specific embodiment of the present disclosure, a Prewitt operator is employed to perform edge detection on the sediment grains in the image with second-stage clustering results. That is, the Prewitt operator is applied to each cluster region in the image with second-stage clustering results to locate and highlight the edge features within each cluster region. By calculating the gradient values at the vertical and horizontal edges of each pixel in the image, regions with significant variations in depth value are identified, such that the edges and contours of the grains can be marked. These grain edge contour maps are then merged to obtain a single unified grain edge contour map. The Prewitt operator used in the present disclosure can identify edges, contours, and important features in the image.

The image binarization module of the present disclosure employs the Otsu's algorithm for automatic thresholding to automatically select a suitable segmentation threshold based on the statistical characteristics of the image, maximizing the variance between the foreground and background to find the optimal segmentation threshold. The grain edge contour map is compared with the segmentation threshold to detect and highlight the distinct edges of the sediment grains.

In the present disclosure, the equivalent transformation module is configured because the characterization results of the relevant parameters for the sediment grains are all in pixel values. To obtain the area of the sediment grains, it is necessary to count the number of the pixels occupied by the sediment grains, perform an equivalent circular diameter transformation on the sediment grain pixel values, then calculate the particle size distribution of the grains based on the equivalent circular diameters, and subsequently output a gradation curve of the sediment grains for the captured area.

The model number of the cameras used in the embodiments of the present disclosure is Daheng MER-031-860U3MC, with a focal length of 111 mm and a pixel size of 14.5 μm. The formula for calculating an equivalent circular diameter is as follows:

$$D = 2 \sqrt{\frac{n {α}^{2} \frac{L}{f}}{π}}$$

where n is the number of the pixels occupied by a sediment grain, α is the pixel value, Lis the perpendicular distance from the camera in the first camera to its captured area, and f is the focal length of the camera in the first camera.

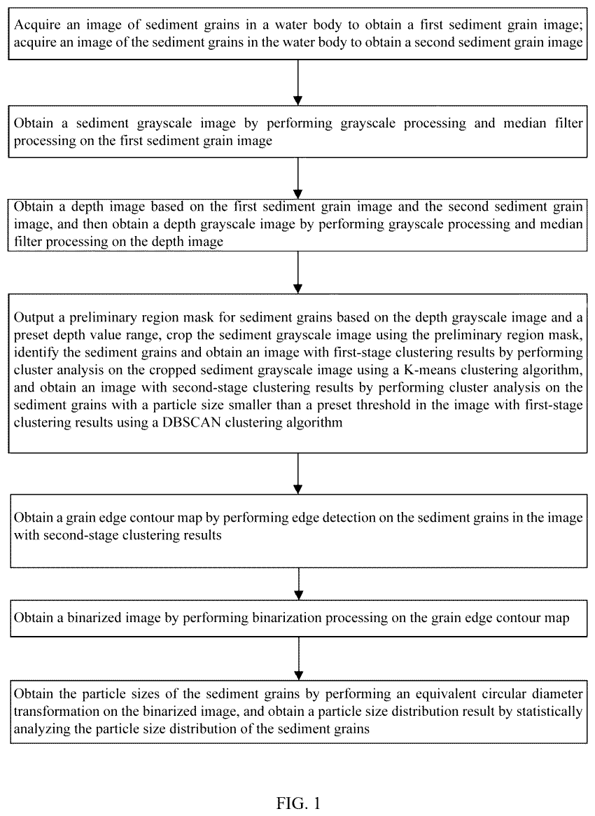

Based on the above system, as shown in FIG. 1, a method for measuring particle size distribution of sediment grains in the present disclosure includes:
acquiring an image of sediment grains in a water body to obtain a first sediment grain image;
acquiring an image of the sediment grains in the water body to obtain a second sediment grain image;
obtaining a sediment grayscale image by performing grayscale processing and median filter processing on the first sediment grain image;
obtaining a depth image based on the first sediment grain image and the second sediment grain image, and then obtaining a depth grayscale image by performing grayscale processing and median filter processing on the depth image;
outputting a preliminary region mask for sediment grains based on the depth grayscale image and a preset depth value range, cropping the sediment grayscale image using the preliminary region mask, identifying the sediment grains and obtaining an image with first-stage clustering results by performing cluster analysis on the cropped sediment grayscale image using a K-means clustering algorithm, and obtaining an image with second-stage clustering results by performing cluster analysis on the sediment grains with a particle size smaller than a preset threshold in the image with first-stage clustering results using a DBSCAN clustering algorithm;
obtaining a grain edge contour map by performing edge detection on the sediment grains in the image with second-stage clustering results;
obtaining a binarized image by performing binarization processing on the grain edge contour map; and
obtaining the particle sizes of the sediment grains by performing an equivalent circular diameter transformation on the binarized image, and obtaining a particle size distribution result by statistically analyzing the particle size distribution of the sediment grains.

In a preferable embodiment, during the cluster analysis on the sediment grayscale image using the K-means clustering algorithm in the method for measuring particle size distribution of sediment grains, a Davies-Bouldin index is used to evaluate the quality of the obtained first-stage clustering results. Based on the obtained evaluation result, the K value in the K-means clustering algorithm is updated using the Q-learning reinforcement learning model. Then, the K-means clustering algorithm with the updated K value is used to re-perform cluster analysis on the sediment grayscale image, until the first-stage clustering results meet the preset clustering performance stability condition.

The system of the present disclosure achieves a real-time processing speed of 1.6105 seconds per image, enabling the system to respond rapidly to changes in water flow. Meanwhile, during algorithm processing and data transmission, the system can dynamically adjust power consumption to adapt to the needs of long-term underwater monitoring, significantly enhancing the system's real-time performance and power management capabilities.

### EMBODIMENT

The present disclosure was tested under the following test conditions. In a laboratory setting, within clear water having a volume of 400 L and a water surface height of approximately 1.6 m, different sediment feeding amounts (480 g, 4000 g, and 8000 g) were set to obtain sediment suspensions of different concentrations. The sediment used was a standard sediment grain sample with a particle size range of 0.002-0.1 mm. Two 2-megapixel industrial cameras were used as the first camera and the second camera, each of which has a focal length of 11 cm. A Malvern laser particle size analyzer was used as a comparative testing device to ensure the authority of the particle size distribution data.

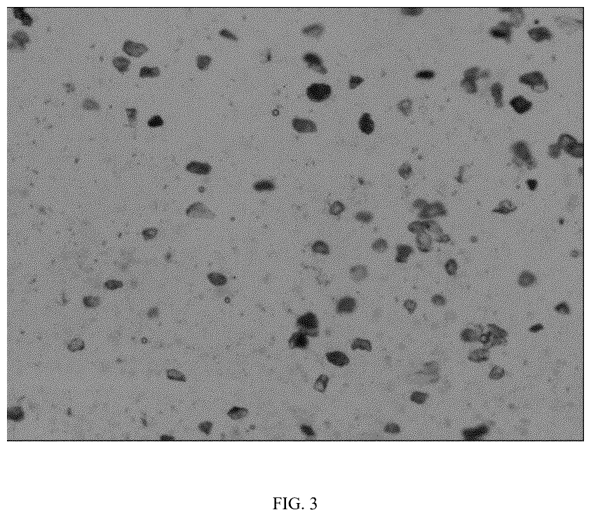

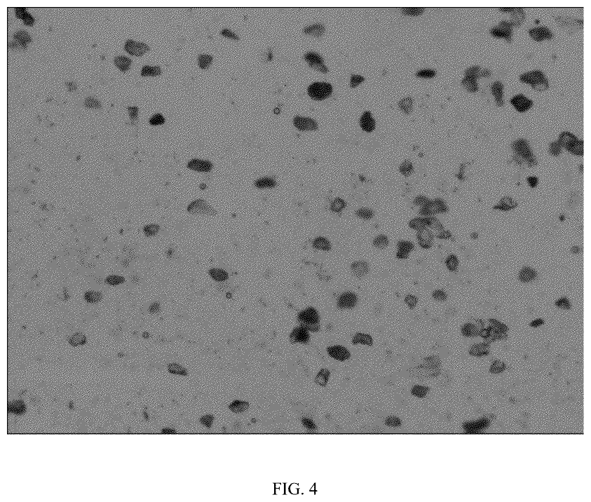

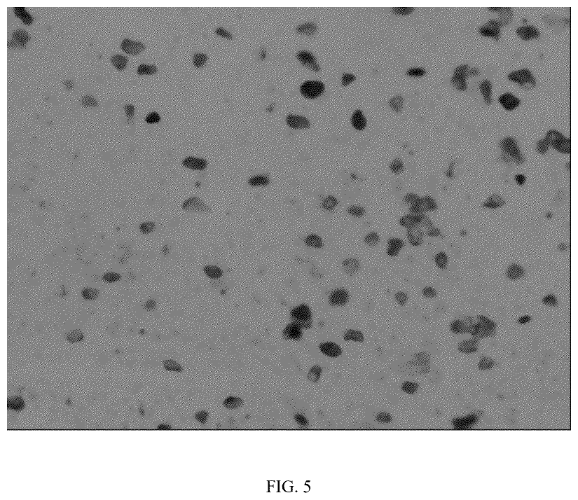

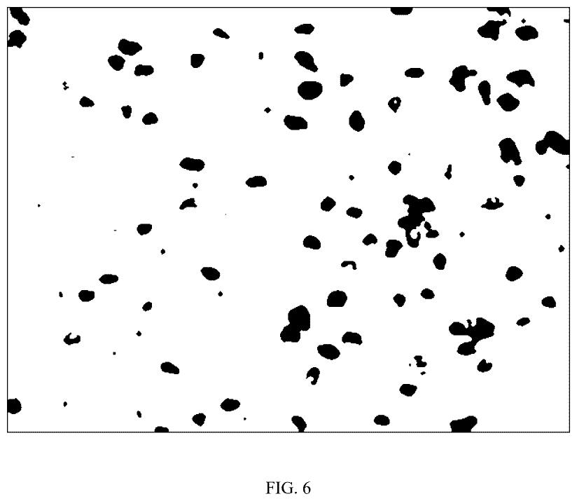

FIG. 3 shows a sediment grain image captured by one of the industrial cameras, in which the suspended state and distribution of the sediment grains are visible. FIG. 4 shows a sediment grayscale image obtained after grayscale processing and median filter processing have been performed on the sediment grain image, the sediment grayscale image providing a simplified input for the K-means clustering algorithm. FIG. 5 shows an image having been processed by the K-means clustering algorithm and the DBSCAN clustering algorithm, in which pixel values are divided into a number of clusters. FIG. 6 shows a clear sediment grain segmentation map generated by calculating pixel gradient values and extracting edge features based on the second-stage clustering results.

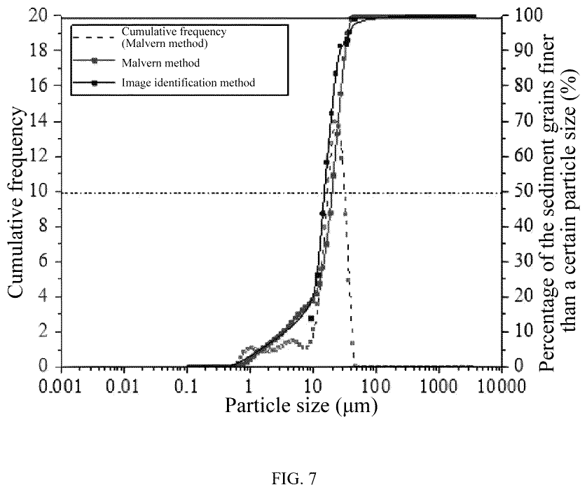

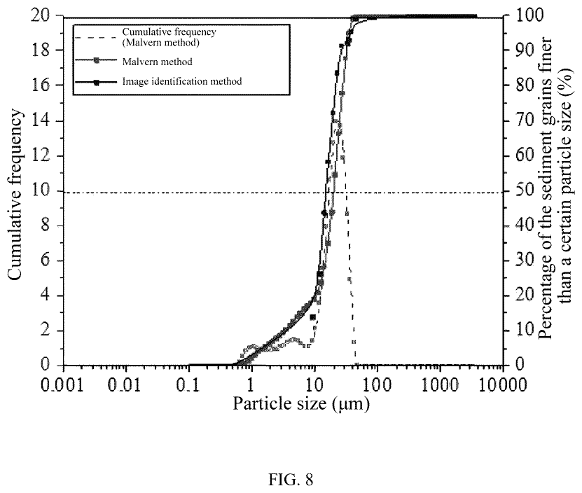

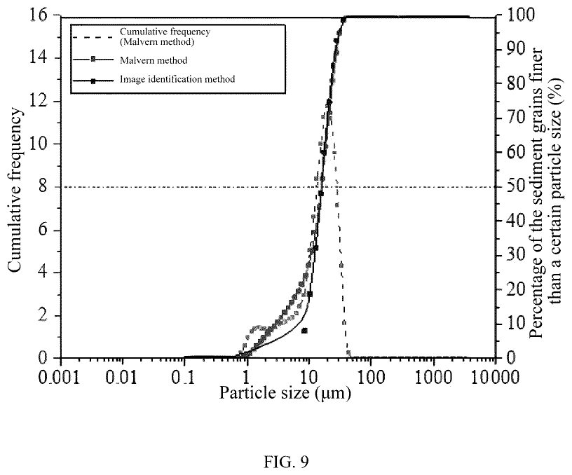

FIGS. 7 to 9 show the particle size gradation curves of sediment grains obtained using the measurement system of the present disclosure (image identification method) and a Malvern laser particle size analyzer (Malvern method) at the sediment feeding amounts of 480 g, 4000 g, and 8000 g, respectively. As can be seen from FIGS. 7 to 9, compared with the sediment grain particle size gradation measurement results obtained by the currently well-established Malvern laser particle size analyzer, the error of the system of the present disclosure ranges between 0.0025 mm and 0.0035 mm. Considering the presence of flocculent fine-grained impurities in the water body, this error is deemed to be within an acceptable range.

In summary, it can be seen that the present disclosure achieves high accuracy in sediment grain identification. Through precise image filtering and an optimized K-means clustering algorithm, the system of the present disclosure can effectively identify fine suspended sediment grains within a particle size range of 0.002-0.1 mm, thereby meeting the requirements for high-precision identification of sediment grains.

This demonstrates that the present disclosure achieves an excellent balance between real-time performance and high precision, exhibiting significant advantages especially in measuring suspended load in natural water bodies. Unlike conventional particle size analyzers that cannot perform real-time analysis of underwater sediment grains, the method of the present disclosure makes real-time monitoring and high-precision identification possible, ensuring the effective application of image identification methods for measuring particle size distribution of sediment grains in complex underwater environments.

What is claimed is:

1. A system for measuring particle size distribution of sediment grains, comprising:
an image acquisition module comprising a first camera and a second camera, wherein the first camera is configured to acquire an image of sediment grains in a water body to obtain a first sediment grain image, and transmit the first sediment grain image to an image preprocessing module, and the second camera is configured to acquire an image of the sediment grains in the water body to obtain a second sediment grain image, and transmit the second sediment grain image to the image preprocessing module;
the image preprocessing module, configured to obtain a sediment grayscale image by performing grayscale processing and median filter processing on the first sediment grain image, and transmit the sediment grayscale image to a grain identification module, and further configured to obtain a depth image based on the first sediment grain image and the second sediment grain image, then obtain a depth grayscale image by performing grayscale processing and median filter processing on the depth image, and transmit the depth grayscale image to the grain identification module;
the grain identification module, configured to output a preliminary region mask for sediment grains based on the depth grayscale image and a preset depth value range, crop the sediment grayscale image using the preliminary region mask, identify the sediment grains and obtain an image with first-stage clustering results by performing cluster analysis on the cropped sediment grayscale image using a K-means clustering algorithm, obtain an image with second-stage clustering results by performing cluster analysis on the sediment grains with a particle size smaller than a preset threshold in the image with first-stage clustering results using a DBSCAN clustering algorithm, and transmit the image with second-stage clustering results to an edge detection module;
the edge detection module, configured to obtain a grain edge contour map by performing edge detection on the sediment grains in the image with second-stage clustering results, and transmit the grain edge contour map to an image binarization module;
the image binarization module, configured to obtain a binarized image by performing binarization processing on the grain edge contour map, and transmit the binarized image to an equivalent transformation module; and
the equivalent transformation module, configured to obtain the particle sizes of the sediment grains by performing an equivalent circular diameter transformation on the binarized image, and obtain a particle size distribution result by statistically analyzing the particle size distribution of the sediment grains.

2. The system for measuring particle size distribution of sediment grains of claim 1, wherein during the cluster analysis on the sediment grayscale image using the K-means clustering algorithm, the grain identification module employs a Davies-Bouldin index to evaluate the quality of the first-stage clustering results, employs a Q-learning reinforcement learning model to update the K value in the K-means clustering algorithm based on the obtained evaluation result, and then employs the K-means clustering algorithm with the updated K value to re-perform cluster analysis on the sediment grayscale image, until the first-stage clustering results meet a preset clustering performance stability condition.

3. The system for measuring particle size distribution of sediment grains of claim 1, wherein the image acquisition module comprises a light source that is a blue light source; and
the light source is configured to provide illumination for the first camera to acquire an image of the sediment grains in the water body.

4. The system for measuring particle size distribution of sediment grains of claim 3, further comprising a power consumption management module, wherein
the power consumption management module comprises:
a light sensor configured to acquire illuminance intensity in the water body and transmit the illuminance intensity to a light source control module; and
the light source control module configured to control the irradiation intensity of the light source based on the illuminance intensity in the water body.

5. The system for measuring particle size distribution of sediment grains of claim 4, wherein the system for measuring particle size distribution of sediment grains further comprises a concentration calculation module, and the power consumption management module further comprises a camera control module;
the concentration calculation module is configured to calculate a concentration of the sediment grains based on the particle size distribution result; and
the camera control module is configured to control the operating frequency of the first camera based on the concentration of the sediment grains.

6. The system for measuring particle size distribution of sediment grains of claim 1, wherein the edge detection module employs a Prewitt operator to perform edge detection on the sediment grains in the image with the second-stage clustering results.

7. A method for measuring particle size distribution of sediment grains, comprising:
acquiring an image of sediment grains in a water body to obtain a first sediment grain image;
acquiring an image of the sediment grains in the water body to obtain a second sediment grain image;
obtaining a sediment grayscale image by performing grayscale processing and median filter processing on the first sediment grain image;
obtaining a depth image based on the first sediment grain image and the second sediment grain image, and then obtaining a depth grayscale image by performing grayscale processing and median filter processing on the depth image;
outputting a preliminary region mask for sediment grains based on the depth grayscale image and a preset depth value range, cropping the sediment grayscale image using the preliminary region mask, identifying the sediment grains and obtaining an image with first-stage clustering results by performing cluster analysis on the cropped sediment grayscale image using a K-means clustering algorithm, and obtaining an image with second-stage clustering results by performing cluster analysis on the sediment grains with a particle size smaller than a preset threshold in the image with first-stage clustering results using a DBSCAN clustering algorithm;
obtaining a grain edge contour map by performing edge detection on the sediment grains in the image with second-stage clustering results;
obtaining a binarized image by performing binarization processing on the grain edge contour map; and
obtaining the particle sizes of the sediment grains by performing an equivalent circular diameter transformation on the binarized image, and obtaining a particle size distribution result by statistically analyzing the particle size distribution of the sediment grains.

8. The method for measuring particle size distribution of sediment grains of claim 7, wherein during the cluster analysis on the sediment grayscale image using the K-means clustering algorithm, a Davies-Bouldin index is used to evaluate the quality of the first-stage clustering results, the K value in the K-means clustering algorithm is updated using a Q-learning reinforcement learning model based on the obtained evaluation result, and then the K-means clustering algorithm with the updated K value is used to re-perform cluster analysis on the sediment grayscale image, until the first-stage clustering results meet a preset clustering performance stability condition.
